(19) United States
(12) Patent Application Publication
(10) Pub. No.: US 2023/0116180 A1
(43) Pub. Date: Apr. 13, 2023

(54) ELECTROCHEMICAL DEVICE

(71) Applicant: Panasonic Intellectual Property Management Co., Ltd., Osaka (JP)

(72) Inventors: KAZUYA MIYAFUJI, Osaka (JP); HIROKI HAYASHI, Kyoto (JP); KENICHI NAGAMITSU, Kyoto (JP)

(21) Appl. No.: 17/906,418

(22) PCT Filed: Mar. 29, 2021
(86) PCT No.: PCT/JP2021/013177

§ 371 Date: Sep. 15, 2022

(30) Foreign Application Priority Data
Mar. 30, 2020 (JP) 2020-061353

(51) Int. Cl. H01M 4/60; H01M 4/04; H01M 4/62

(52) U.S. Cl. CPC H01M 4/606; H01M 4/0404; H01M 4/625; H01M 2004/021

(57) ABSTRACT

An electrochemical device includes a positive electrode including a positive current collector and a positive electrode material layer supported on the positive current collector, a negative electrode, and an electrolytic solution. The positive electrode material layer includes a conductive polymer, and a surface roughness (Ra) of the positive current collector is in a range from 0.7 μm to 1.7 μm, inclusive.

### TECHNICAL FIELD

The present invention relates to an electrochemical device that includes an active layer containing a conductive polymer.

### BACKGROUND

In recent years, an electrochemical device having performance intermediate between a lithium ion secondary battery and an electric double layer capacitor attracts attention, and for example, use of a conductive polymer as a positive electrode material is considered (for example, PTL 1). Since the electrochemical device containing the conductive polymer as the positive electrode material is charged and discharged by adsorption (doping) and desorption (dedoping) of anions, the electrochemical device has a small reaction resistance and has higher output than output of a general lithium ion secondary battery.

### CITATION LIST

### Patent Literature

PTL 1: Unexamined Japanese Patent Publication No. 2014-35836

### SUMMARY

A conductive polymer as a positive electrode material is supported on a positive current collector to realize an electrochemical device. However, the conductive polymer has low adhesion to the positive current collector, and the internal resistance tends to increase due to interface resistance with the positive current collector. In addition, the conductive polymer is easily peeled off from the positive current collector, and the internal resistance easily increases in long-term use.

In view of the above, one aspect of the present invention relates to an electrochemical device including a positive electrode including a positive current collector and a positive electrode material layer supported on the positive current collector, a negative electrode, and an electrolytic solution, in which the positive electrode material layer includes a conductive polymer, and a surface roughness (Ra) of the positive current collector is in a range from 0.7 μm to 1.7 μm, inclusive.

According to the present disclosure, the internal resistance of the electrochemical device can be reduced.

### BRIEF DESCRIPTION OF THE DRAWINGS

FIG. 1 is a vertical cross-sectional view illustrating a configuration of an electrochemical device according to an exemplary embodiment of the present invention.

### DESCRIPTION OF EMBODIMENT

An electrochemical device according to an exemplary embodiment of the present disclosure includes a positive electrode including a positive current collector and a positive electrode material layer supported on the positive current collector, a negative electrode, and an electrolytic solution. The positive electrode material layer contains a conductive polymer. The surface roughness (Ra) of the positive current collector is in the range from 0.7 μm to 1.7 μm, inclusive.

In the electrochemical device of the present exemplary embodiment, the internal resistance (particularly interface resistance between the positive current collector and the positive electrode material layer) is reduced by setting the surface roughness (Ra) of the positive current collector within the above range.

By setting the surface roughness (Ra) of the positive current collector to more than or equal to 0.7 μm, adhesion to the conductive polymer is improved, and thus the internal resistance can be reduced. On the other hand, as the surface roughness (Ra) of the positive current collector increases, the area of the interface between the positive current collector and the conductive polymer increases, and thus the interface becomes more easily react with the electrolytic solution. In addition, the positive electrode material layer is likely to be peeled off from the positive current collector, and the interface resistance may increase due to long-term use so that the internal resistance increases. By setting the surface roughness (Ra) of the positive current collector to less than or equal to 1.7 μm, a side reaction between the conductive polymer and the electrolytic solution is suppressed, and peeling of the positive electrode material layer is suppressed. Hence, the internal resistance can be maintained low even in long-term use.

The surface roughness (Ra) of the positive current collector is an arithmetic average roughness Ra defined in JIS B 0601: 1994 and is determined on the basis of a roughness curve derived by acquiring a cross-sectional photograph of a region including an interface between the positive current collector and the positive electrode material layer with a scanning electron microscope or the like and performing image analysis on the cross-sectional photograph.

The particle size of the conductive polymer is preferably in the range from 2 μm to 20 μm, inclusive. When the particle size of the conductive polymer is less than or equal to 20 μm, a contact area between the positive current collector and the conductive polymer can be increased, and the resistance is reduced. On the other hand, by setting the particle size of the conductive polymer to more than or equal to 2 μm, a side reaction between the conductive polymer and the electrolytic solution is suppressed, and the internal resistance can be maintained low even in long-term use.

In the above description, the particle size of the conductive polymer means an average particle size. The average particle size is a median diameter (D50) in a volume-based particle size distribution obtained with a laser diffraction particle size distribution analyzer. The average particle size may be calculated by observation with a scanning electron microscope. From the cross-sectional photograph of the positive electrode material layer, the grain boundary of the conductive polymer is determined by image analysis, and the diameter of a circle (equivalent circle) having the same area as the grain in the cross section is determined. The particle size of the conductive polymer is derived by determining the median value of the diameters of the equivalent circles for a plurality of (such as 100 or more) particles of the conductive polymer.

The surface roughness (Ra) of the positive current collector is represented by A, and the particle size of the conductive polymer is represented by B. The ratio B/A may be less than or equal to 16.7, preferably in the range from 1.7 to 16.7, inclusive. In this range, the internal resistance of the electrochemical device can be remarkably reduced.

A carbon layer may be interposed between the positive current collector and the positive electrode material layer. By forming the carbon layer on the positive current collector, the conductive polymer adheres to the carbon layer, and the resistance between the positive electrode material layer and the positive current collector can be reduced. In this case, the particle size of the conductive carbon material contained in the carbon layer is preferably in the range from 0.2 μm to 1.0 μm, inclusive. The conductive carbon material having a particle size of more than or equal to 0.2 μm is firmly interlocked with irregularities on the surface of the positive current collector and easily reduces contact resistance. In addition, since aggregation is hardly caused, it is easy to produce a carbon paste in which the conductive carbon material is dispersed. On the other hand, when the particle size is less than or equal to 1.0 μm, the joining strength between the conductive polymer and the carbon layer is improved, and thus the joining strength between the carbon layer and the positive current collector is also improved. Hence, peeling of the carbon layer from the positive current collector is suppressed, and the internal resistance can be maintained low even in long-term use.

As with the particle size of the conductive polymer, the particle size of the conductive carbon material means an average particle size. As with the particle size of the conductive polymer, the average particle size may be calculated by observation with a scanning electron microscope.

The conductive polymer may include polyaniline. Among conductive polymers, polyaniline hardly adheres to the positive current collector, and hardly reduces the internal resistance of the electrochemical device. The latter problem is considered to be because a side reaction is likely to occur at the interface between polyaniline and the positive current collector. Particularly, polyaniline is likely to deteriorate due to an alcohol component that can be generated by the reaction of the electrolytic solution at the negative electrode.

However, with the above configuration, the resistance between polyaniline and the positive current collector can be remarkably reduced, and the internal resistance of the electrochemical device can be reduced. This is considered to be because the positive current collector and the conductive polymer (polyaniline) interlock with each other in a larger area and have voids advantageous for movement of anions. As a result, an electrochemical device having a high capacitance and excellent rapid charge-discharge characteristics can be realized.

Polyaniline is a polymer containing aniline (C₆H₅—NH₂) as a monomer. Polyaniline includes polyaniline and derivatives thereof. The derivatives of polyaniline mean polymers having polyaniline as a basic skeleton. The polyaniline of the present disclosure includes, for example, a derivative compound in which an alkyl group such as a methyl group is attached to a part of the benzene ring of aniline and a derivative compound in which a halogen group or the like is attached to a part of the benzene ring of aniline, as long as the compound and the derivative are polymers containing aniline as a basic skeleton.

### <<Electrochemical Device>>

Hereinafter, a configuration of the electrochemical device according to the present invention will be described in more detail with reference to the drawing.

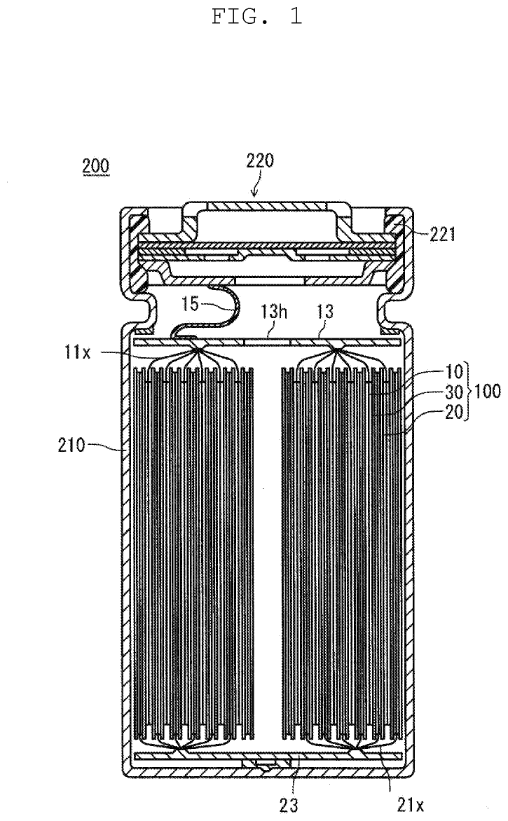

FIG. 1 is a longitudinal cross-sectional view illustrating an outline of a configuration of electrochemical device 200 according to one exemplary embodiment of the present invention. Electrochemical device 200 is provided with electrode body 100, a non-aqueous electrolytic solution (not shown), metallic bottomed cell case 210 housing electrode body 100 and the non-aqueous electrolytic solution, and sealing plate 220 sealing an opening of cell case 210.

Electrode body 100 is configured as a columnar wound body by, for example, winding a belt-shaped negative electrode and a belt-shaped positive electrode together with a separator interposed between them. Electrode body 100 may also be formed as a stacked body in which a plate-like positive electrode and a plate-like negative electrode are stacked with a separator interposed between them. The positive electrode is provided with a positive electrode core material (positive current collector) and a positive electrode material layer supported by the positive electrode core material. The negative electrode is provided with a negative electrode core material (negative current collector) and a negative electrode material layer supported by the negative electrode core material.

Gasket 221 is disposed on the peripheral edge of sealing plate 220, and the open end of cell case 210 is caulked by gasket 221, whereby the inside of cell case 210 is sealed. Positive electrode current collecting plate 13 having through hole 13h in the center is welded to positive-electrode-core-material exposed part 11x. The other end of tab lead 15 having one end connected to positive electrode current collecting plate 13 is connected to an inner surface of sealing plate 220. Thus, sealing plate 220 has a function as an external positive electrode terminal. On the other hand, negative electrode current collecting plate 23 is welded to negative-electrode-core-material exposed part 21x. Negative electrode current collecting plate 23 is directly welded to a welding member provided on the inner bottom surface of cell case 210. Hence, cell case 210 has a function as an external negative electrode terminal.

### (Positive Electrode Core Material)

A sheet-shaped metallic material is used as the positive electrode core material. The sheet-shaped metallic material may be a metal foil, a porous metal body, an etched metal, or the like. As the metallic material, aluminum, aluminum alloy, nickel, titanium, or the like can be used. The thickness of the positive electrode core material is, for example, in the range from 10 μm to 100 μm, inclusive. A carbon layer may be formed on the positive electrode core material. The carbon layer is interposed between the positive electrode core material and the positive electrode material layer and has a function of, for example, reducing the resistance between the positive electrode core material and the positive electrode material layer and improving the current collecting property from the positive electrode material layer to the positive electrode core material.

As the positive electrode core material, one having a surface roughness (Ra) in the range from 0.7 μm to 1.7 μm, inclusive is used. The surface roughness (Ra) can be controlled to be a desired value, for example, by etching the surface of the positive electrode core material.

### (Carbon Layer)

The carbon layer is formed, for example, by depositing a conductive carbon material on the surface of the positive electrode core material or forming a coating film of a carbon paste containing a conductive carbon material and drying the coating film. The carbon paste includes, for example, a conductive carbon material, a polymer material, and water or an organic solvent. The thickness of the carbon layer may be, for example, in the range from 1 μm to 20 μm, inclusive. As the conductive carbon material, graphite, hard carbon, soft carbon, carbon black, or the like may be used. Among them, carbon black may form a thin carbon layer having excellent conductivity. As the polymer material, fluorine resin, acrylic resin, polyvinyl chloride, styrene-butadiene rubber (SBR), or the like may be used. The particle size of the conductive carbon material is preferably in the range from 0.2 μm to 1.0 μm, inclusive.

### (Positive Electrode Material Layer)

The positive electrode material layer contains a conductive polymer as a positive electrode active material. The positive electrode material layer may contain a conductive agent, a binder, and the like in addition to the positive electrode active material. Examples of the conductive agent include carbon black and carbon fiber. Examples of the binder include a fluorine resin, an acrylic resin, a rubber material, and a cellulose derivative.

In the conductive polymer, the conductive polymer is doped with anions in the electrolytic solution during charging, and the anions with which the conductive polymer has been doped move into the electrolytic solution during discharging, thereby contributing to charging and discharging. A weight-average molecular weight of the conductive polymer is not particularly limited and ranges from 1,000 to 100,000, inclusive, for example.

The positive electrode material layer can be formed by, for example, mixing the positive electrode active material, the conductive agent, the binder, and the like with a dispersion medium to prepare a positive electrode mixture paste, applying the positive electrode mixture paste to the positive electrode core material, and then drying the positive electrode mixture paste. The thickness of the positive electrode material layer is, for example, in the range from 10 μm to 300 μm, inclusive, per surface.

In the present exemplary embodiment, the conductive polymer includes polyaniline. When the positive electrode material layer contains polyaniline as a conductive polymer, the proportion of the polyaniline to all conductive polymers constituting the positive electrode material layer may be more than or equal to 90 mass %.

The positive electrode material layer may contain a conductive polymer other than the polyaniline. As the conductive polymer usable together with the polyaniline, a π-conjugated polymer is preferable. Examples of the π-conjugated polymer that can be used include polypyrrole, polythiophene, polyfuran, polythiophene vinylene, polypyridine, and derivatives of these polymers. A weight-average molecular weight of the conductive polymer is not particularly limited and ranges from 1,000 to 100,000, inclusive, for example. As a raw material monomer of the conductive polymer usable together with the polyaniline, it is possible to use, for example, pyrrole, thiophene, furan, thiophene vinylene, pyridine, and derivatives of these monomers. The raw material monomer may include an oligomer.

Derivatives of polypyrrole, polythiophene, polyfuran, polythiophene vinylene, and polypyridine mean polymers having, as a basic skeleton, polypyrrole, polythiophene, polyfuran, polythiophene vinylene, and polypyridine, respectively. For example, a polythiophene derivative includes poly(3,4-ethylenedioxythiophene) (PEDOT) and the like.

The particle size of the conductive polymer is preferably in the range from 2 μm to 20 μm, inclusive.

The positive electrode material layer containing the conductive polymer may be formed on the positive electrode core material (or on the carbon layer) by electrolytic polymerization or chemical polymerization. Electrolytic polymerization is performed, for example, by immersing the positive electrode core material provided with the carbon layer in a reaction solution containing a raw material monomer of the conductive polymer and allowing the raw material monomer to react in the presence of the positive electrode core material. At this time, by performing electrolytic polymerization with the positive electrode core material as an anode, the positive electrode material layer containing the conductive polymer is formed so as to cover the carbon layer. The thickness of the positive electrode material layer can be controlled by the electrolytic current density, the polymerization time, and the like. The particle size of the conductive polymer can be controlled by the stirring speed of the polymerization solution and the raw material monomer concentration in the case of chemical polymerization or the viscosity of the polymerization solution and the raw material monomer concentration in the case of electrolytic polymerization.

The positive electrode material layer containing a conductive polymer may be formed by chemical polymerization of a raw material monomer. The positive electrode material layer may also be formed by using a conductive polymer synthesized in advance or a dispersion thereof.

The electrolytic polymerization or the chemical polymerization is preferably performed using a reaction solution containing a dopant. The dispersion liquid or the solution of the conductive polymer also preferably contains a dopant. A 7c-electron conjugated polymer doped with a dopant exhibits excellent conductivity. For example, in chemical polymerization, the positive electrode core material may be immersed in a reaction solution containing a dopant, an oxidizing agent, and a raw material monomer, then withdrawn from the reaction solution, and dried. In the electrolytic polymerization, the positive electrode core material and a counter electrode may be immersed in a reaction solution containing a dopant and a raw material monomer, and a current may flow between the positive electrode core material as an anode and the counter electrode as a cathode.

As the solvent of the reaction solution, water may be used, or a non-aqueous solvent may be used in consideration of solubility of the monomer. As the non-aqueous solvent, preferably used are, for example, alcohols such as ethyl alcohol, methyl alcohol, isopropyl alcohol, ethylene glycol, and propylene glycol. A dispersion medium or solvent of the conductive polymer is also exemplified by water and the non-aqueous solvents described above.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆⁻), a fluorosulfate ion (FSO₃⁻), a bis(fluorosulfonyl)imide ion (N(FSO₂)₂⁻), and a bis(trifluoromethanesulfonyl)imide ion (N(CF₃SO₂)₂⁻). These may be used alone or may be used in combination of two or more kinds.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These dopants may be a homopolymer or a copolymer of two or more monomers. These may be used alone or may be used in combination of two or more kinds.

### (Positive Electrode Current Collecting Plate)

The positive electrode current collecting plate is a metal plate having a substantially disk shape. It is preferable to form a through hole serving as a passage for the non-aqueous electrolyte in the central part of the positive electrode current collecting plate. The material of the positive electrode current collecting plate is, for example, aluminum, aluminum alloy, titanium, stainless steel, or the like. The material of the positive electrode current collecting plate may be the same as the material of the positive electrode core material.

### (Negative Electrode Core Material)

A sheet-shaped metallic material is also used for the negative electrode core material. The sheet-shaped metallic material may be a metal foil, a porous metal body, an etched metal, or the like. As the metallic material, copper, copper alloy, nickel, stainless steel, or the like may be used. The thickness of the negative electrode core material is, for example, in the range from 10 μm to 100 μm, inclusive.

### (Negative Electrode Material Layer)

The negative electrode material layer includes a material that electrochemically absorbs and releases lithium ions as a negative electrode active material. Lithium ions in the electrolytic solution are occluded in the negative electrode material during charging, and lithium ions released from the negative electrode material move into the electrolytic solution during discharging, thereby contributing to charging and discharging. Examples of such a material include a carbon material, a metal compound, an alloy, and a ceramic material. As the carbon material, graphite, hardly-graphitizable carbon (hard carbon), and easily-graphitizable carbon (soft carbon) are preferable, and graphite and hard carbon are particularly preferable. Examples of the metal compound include silicon oxides and tin oxides. Examples of the alloy include silicon alloys and tin alloys. Examples of the ceramic material include lithium titanate and lithium manganate. These may be used alone or may be used in combination of two or more kinds. Among these materials, a carbon material is preferable in terms of being capable of decreasing a potential of the negative electrode.

The negative electrode material layer may contain a conductive agent, a binder, and the like in addition to the negative electrode active material. Examples of the conductive agent include carbon black and carbon fiber. Examples of the binder include a fluorine resin, an acrylic resin, a rubber material, and a cellulose derivative.

The negative electrode material layer is formed by, for example, mixing the negative electrode active material, the conductive agent, the binder, and the like with a dispersion medium to prepare a negative electrode mixture paste, applying the negative electrode mixture paste to the negative electrode core material, and then drying the negative electrode mixture paste. The thickness of the negative electrode material layer is, for example, in the range from 10 μm to 300 μm, inclusive, per surface.

The negative electrode material layer is preferably pre-doped with lithium ions in advance. This decreases the potential of the negative electrode and therefore increases a difference in potential (that is, voltage) between the positive electrode and the negative electrode and improves energy density of the electrochemical device.

Pre-doping of the negative electrode with the lithium ions is progressed by, for example, forming a metallic lithium layer that is to serve as a supply source of lithium ions on a surface of the negative electrode material layer and impregnating the negative electrode including the metallic lithium layer with an electrolytic solution (for example, a non-aqueous electrolytic solution) having lithium ion conductivity. At this time, lithium ions are eluted from the metallic lithium layer into the non-aqueous electrolytic solution, and the eluted lithium ions are occluded in the negative electrode active material. For example, when graphite or hard carbon is used as the negative electrode active material, lithium ions are inserted in between layers of graphite or in fine pores of hard carbon. The amount of lithium ions for the pre-doping may be controlled by the mass of the metallic lithium layer. The amount of lithium for the pre-doping may be, for example, in the range from about 50% to 95%, inclusive, of the maximum amount that can be occluded in the negative electrode material layer.

The step of pre-doping the negative electrode with lithium ions may be performed before the electrode group is assembled, or the pre-doping may be progressed after the electrode group is housed in a case of the electrochemical device together with the non-aqueous electrolytic solution.

### (Negative Electrode Current Collecting Plate)

The negative electrode current collecting plate is a metal plate having a substantially disk shape. The material of the negative electrode current collecting plate is, for example, copper, copper alloy, nickel, stainless steel, or the like. The material of the negative electrode current collecting plate may be the same as the material of the negative electrode core material.

### (Separator)

As the separator, a nonwoven fabric made of cellulose fiber, a nonwoven fabric made of glass fiber, a microporous film made of polyolefin, a woven fabric, a nonwoven fabric, or the like may be used. The thickness of the separator is, for example, in the range from 10 μm to 300 μm, inclusive, preferably from 10 μm to 40 μm, inclusive.

### (Electrolytic Solution)

The electrolytic solution has lithium ion conductivity and contains a lithium salt and a solvent that dissolves the lithium salt. In this case, doping and dedoping of the positive electrode with the anions of the lithium salt can be reversibly repeated. On the other hand, lithium ions derived from the lithium salt are reversibly stored and released in and from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. These lithium salts may be used alone or in combination of two or more of these lithium salts. Among these lithium salts, preferably used are at least one selected from the group consisting of a lithium salt having a halogen atom-containing oxo acid anion suitable as the anions, and a lithium salt having an imide anion. It is preferable to use an electrolytic solution containing lithium hexafluorophosphate from the viewpoint of enhancing the ion conductivity of the electrolytic solution and suppressing corrosion of metal parts such as current collectors and leads.

The concentration of the lithium salt in the electrolytic solution in the charged state (charging rate (SOC) ranging from 90% to 100%) ranges, for example, from 0.2 mol/L to 5 mol/L, inclusive.

The solvent may be a non-aqueous solvent. As the non-aqueous solvent, it is possible to use, for example, cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone (GBL) and γ-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; dimethyl sulfoxide, 1,3-dioxolane, formamide, acetamide, dimethylformamide, dioxolane, acetonitrile, propionitrile, nitromethane, ethylmonoglyme, trimethoxymethane, sulfolane, methyl sulfolane, and 1,3-propanesultone. These may be used alone or in combination of two or more thereof.

The non-aqueous electrolytic solution may contain an additive agent in the non-aqueous solvent as necessary. For example, an unsaturated carbonate such as vinylene carbonate, vinyl ethylene carbonate, or divinyl ethylene carbonate may be added as an additive agent (coating film formation agent) for forming a coating having high lithium ion conductivity on the surface of the negative electrode.

In the above-described exemplary embodiment, a wound electrochemical device having a cylindrical shape has been described. The scope of application of the present invention is not limited to the exemplary embodiment described above, and the present invention is also applicable to a wound or laminated electrochemical device having a rectangular shape.

### Examples

Hereinafter, the present invention will be described in more detail based on examples, but the present invention is not limited to the examples.

### <<Electrochemical Devices A1 to A7, B1, and B2>>

### (1) Production of Positive Electrode

An aluminum foil having a thickness of 30 μm was prepared as a positive current collector. The aluminum foil whose surface was roughened by etching was prepared.

A positive electrode mixture paste was prepared by mixing polyaniline (weight-average molecular weight of 130,000) as the conductive polymer, a dispersion liquid of a conductive agent, a solution of carboxycellulose (CMC), and a dispersion liquid of styrene-butadiene rubber (SBR) at a mass ratio of 100:17.5:3.0:10. The dispersion liquid of the conductive agent was constituted of carbon black and water with a mass ratio of the conductive agent:water=20:80. The solution of CMC was constituted of CMC and water with a mass ratio of CMC:water=5:95. The dispersion liquid of SBR was constituted of SBR and water with a mass ratio of SBR:water=40:60. As polyaniline, one classified to a desired particle size was used. The positive electrode mixture paste was applied to both surfaces of the positive current collector and dried to obtain a positive electrode having a positive electrode material layer having a thickness of 35 μm on both surfaces.

### (2) Production of Negative Electrode

A copper foil having a thickness of 20 μm was prepared as a negative current collector. A negative electrode mixture paste was prepared by kneading a mixed powder containing 97 parts by mass of hard carbon, 1 part by mass of carboxycellulose, and 2 parts by mass of styrene-butadiene rubber with water at a weight ratio of 40:60. The negative electrode mixture paste was applied to both surfaces of the negative current collector and dried to obtain a negative electrode having a negative electrode material layer having a thickness of 35 μm on both surfaces. Next, a metallic lithium foil was attached to the negative electrode material layer in an amount calculated such that the negative electrode that was in an electrolytic solution after completion of pre-doping had a potential of less than or equal to 0.2 V with respect to the potential of metallic lithium.

### (3) Production of Electrode Group

Lead tabs were respectively connected to the positive electrode and the negative electrode, and then, as shown in FIG. 3, a stacked body in which a nonwoven fabric separator (thickness 35 μm) made of cellulose, the positive electrode, and the negative electrode are alternately stacked on each other was wound to form an electrode group.

### (4) Preparation of Electrolytic Solution

A solvent was prepared by adding 0.2 mass % of vinylene carbonate to a mixture of propylene carbonate and dimethyl carbonate in a volume ratio of 1:1. LiPF₆ was dissolved as a lithium salt in the obtained solvent at a predetermined concentration to prepare a non-aqueous electrolytic solution.

### (5) Production of Electrochemical Device

The electrode group and the electrolytic solution were housed in a bottomed container having an opening to assemble the electrochemical device illustrated in FIG. 2. Thereafter, aging was performed by applying a charge voltage of 3.8 V between terminals of the positive electrode and the negative electrode at 25° C. for 24 hours to progress pre-doping of the negative electrode with lithium ions. In this way, an electrochemical device was fabricated.

The surface roughness (Ra) A of the aluminum foil in the positive current collector and/or the particle size B of polyaniline as the conductive polymer were changed to produce a plurality of types of electrochemical devices A1 to A7, B1, and B2 having different combinations of the surface roughness A and the particle size B of polyaniline. Table 1 shows a list of the surface roughness A, the particle size B of polyaniline, and the ratio B/A in electrochemical devices A1 to A7, B1, and B2.

### <<Electrochemical Device B3>>

In the production of the positive electrode, an unetched aluminum foil was used as the positive current collector. Except for the above, electrochemical device B3 was produced in the same manner as for electrochemical device A1.

### <<Electrochemical Devices A8 to A12>>

In the production of the positive electrode, an etched aluminum foil having a thickness of 30 μm was prepared as the positive current collector. Next, a carbon paste obtained by kneading carbon black with water was applied to entire front and back surfaces of the positive current collector and then dried by heating to form a carbon layer. The carbon layer had a thickness of 2 μm per surface.

The positive electrode mixture paste was applied to the carbon layer on both surfaces of the positive current collector and dried to obtain a positive electrode having a positive electrode material layer having a thickness of 35 μm on both surfaces. Except for the above, electrochemical device B2 was produced in the same manner as for electrochemical device A1.

A plurality of types of electrochemical devices A9 to A13 having different particle sizes of carbon black in the carbon paste were produced. Table 2 shows a list of the surface roughness A, the particle size B of polyaniline, and the particle size C of carbon black in electrochemical devices A9 to A12.

### <<Electrochemical Device B4>>

In the production of the positive electrode, an unetched aluminum foil was used as the positive current collector. Except for the above, electrochemical device B4 was produced in the same manner as for electrochemical device A10.

### (Evaluation)

### (1) Internal Resistance (DCR)

An initial internal resistance (DCR) R₁ was obtained from an amount of voltage drop when the electrochemical device was charged at a voltage of 3.6 V and then discharged for a predetermined time (0.05 seconds to 0.2 seconds) in an environment of 25° C.

### (2) DCR Retention Ratio

The electrochemical device was maintained in a state where a voltage of 3.45 V was applied in an environment of 25° C. for 1,000 hours. Thereafter, the electrochemical device was charged at a voltage of 3.6 V and then discharged, and the internal resistance (DCR) R₂ after the float test was determined in the same manner as for the initial internal resistance R₁. The ratio X=R₂/R₁ of R₂ to R₁ was evaluated as a DCR retention ratio.

Table 1 shows evaluation results of the initial internal resistance (DCR) R₁ and the DCR retention ratio in electrochemical devices A1 to A8, B1 to B3. Table 2 shows evaluation results of the initial internal resistance (DCR) R₁ and the DCR retention ratio in electrochemical devices A9 to A11, and B4 to B6. The initial internal resistance (DCR) R₁ and the DCR retention ratio are each represented as a relative value with the value in electrochemical device B3 being 100.

From Table 1, in electrochemical devices A1 to A8 in which the surface roughness (Ra) of the aluminum foil in the positive current collector is in the range from 0.7 μm to 1.7 μm, inclusive, the initial internal resistance R₁ can be reduced and an increase in the internal resistance due to the long-term use can be suppressed as compared with electrochemical devices B1 to B3. In particular, in electrochemical devices A1 to A3, A5, and A6 in which the ratio B/A of the particle size B of the conductive polymer to the surface roughness (Ra) A is in the range from 1.7 to 16.7, inclusive, a decrease in the initial internal resistance R₁ and an improvement in the DCR retention ratio are remarkable.

Table 2 reveals that when the positive electrode material layer containing the conductive polymer is formed on the carbon layer, in electrochemical devices A8 to A11 in which the particle size of the conductive carbon material is less than or equal to 1.0 μm, a decrease in the initial internal resistance R₁ and an improvement in the DCR retention ratio are remarkable. However, when the particle size is less than 0.1 μm, the conductive carbon material is likely to aggregate, and it may be difficult to produce a carbon paste. In this respect, electrochemical devices A9 to A11 having particle sizes in the range from 0.2 μm to 1.0 μm, inclusive, are preferable.

TABLE 1

| | Surface roughness | | | | |
|---|---|---|---|---|---|
| | (Ra) A of | Particle size | | Initial | DCR |
| | positive current | B of conductive | | DCR | retention |
| | collector (μm) | polymer (μm) | B/A | R₁ | ratio |
| B1 | 0.5 | 6.4 | 12.8 | 52 | 81 |
| A1 | 0.7 | 6.4 | 9.1 | 34 | 70 |
| A2 | 1.2 | 6.4 | 5.3 | 33 | 70 |
| A3 | 1.7 | 6.4 | 3.8 | 34 | 70 |
| B2 | 1.9 | 6.4 | 3.4 | 34 | 87 |
| A4 | 1.2 | 1 | 0.8 | 34 | 85 |
| A5 | 1.2 | 2 | 1.7 | 33 | 70 |
| A6 | 1.2 | 20 | 16.7 | 33 | 70 |
| A7 | 1.2 | 22 | 18.3 | 40 | 79 |
| B3 | — | 6.4 | — | 100 | 100 |

TABLE 2

| | Surface | | | | |
|---|---|---|---|---|---|
| | roughness (Ra) | Particle | Particle | | DCR |
| | A of positive | size B of | size C of | Initial | reten- |
| | current | conductive | carbon | DCR | tion |
| | collector (μm) | polymer (μm) | particles (μm) | R₁ | ratio |
| A8 | 1.2 | 6.4 | 0.1 | 30 | 63 |
| A9 | 1.2 | 6.4 | 0.2 | 30 | 63 |
| A10 | 1.2 | 6.4 | 0.6 | 27 | 63 |
| A11 | 1.2 | 6.4 | 1 | 29 | 63 |
| A12 | 1.2 | 6.4 | 1.1 | 30 | 80 |
| B4 | — | 6.4 | 0.6 | 41 | 83 |

### INDUSTRIAL APPLICABILITY

The electrochemical device according to the present invention has excellent rapid charge-discharge characteristics because of the low internal resistance and can be suitably used as various power sources.

### REFERENCE MARKS IN THE DRAWINGS

100 electrode body
10 positive electrode
11x positive-electrode-core-material exposed part
13 positive electrode current collecting plate
15 tab lead
20 negative electrode
21x negative-electrode-core-material exposed part
23 negative electrode current collecting plate
30 separator
200 electrochemical device
210 cell case
220 sealing plate
221 gasket

1. An electrochemical device comprising:
a positive electrode including a positive current collector and a positive electrode material layer supported on the positive current collector;
a negative electrode; and
an electrolytic solution,
wherein:
the positive electrode material layer includes a conductive polymer, and
a surface roughness (Ra) of the positive current collector is in a range from 0.7 μm to 1.7 μm, inclusive.

2. The electrochemical device according to claim 1, wherein a particle size of the conductive polymer is in a range from 2 μm to 20 μm, inclusive.

3. The electrochemical device according to claim 2, wherein a ratio B/A of a particle size B of the conductive polymer to a surface roughness (Ra) A of the positive current collector is less than or equal to 16.7.

4. The electrochemical device according to claim 1, further comprising
a carbon layer interposed between the positive current collector and the positive electrode material layer,
wherein a particle size of a conductive carbon material contained in the carbon layer is in a range from 0.2 μm to 1.0 μm, inclusive.

5. The electrochemical device according to claim 1, wherein the conductive polymer contains polyaniline.
